(19) United States
(12) Patent Application Publication
(10) Pub. No.: US 2007/0001055 A1
(43) Pub. Date: Jan. 4, 2007

(54) Device for cargo disposition in an aircraft and for jettison said cargo therefrom

(76) Inventors: Vallery Ilyich Smetannikov, Moscow (RU); Andrey Valeryevich Smetannikov, Moscow (RU); Nikolay Dmitriyevich Talikov, Moscow (RU)

Correspondence Address: MCDERMOTT WILL & EMERY LLP, 600 13TH STREET, N.W., WASHINGTON, DC, 20005-3096, US

(21) Appl. No.: 10/569,551

(22) PCT Filed: Jun. 25, 2003
(86) PCT No.: PCT/RU03/00273

§ 371 Date: Feb. 27, 2006

(51) Int. Cl. B64C 1/22

(52) U.S. Cl. 244/137.1

(57) ABSTRACT

The invention relates to aircraft equipment, namely to means for cargo disposition in an aircraft and for jettison thereof without parachuting. The inventive device comprises pallets arranged in the cargo section of the aircraft means for fixing cargo on the pallets and for fixing pallets prior to the jettison position thereof. Each cargo fixing means is embodied in the form of two clamp strips embracing the cargo packages (sacks or nets) stacked on the pallet on a vertical plane and on a parallel direction with respect to the longitudinal axis of the aircraft. Said strips are separate from each other and from the pallet with lower part thereof and connected to each other on the top of the cargo by means of a transverse draft. Said pallets are placed along the longitudinal axis of the aircraft in guides and are displaceable by gravity and/or inertia to the jettison position thereof. The device for fixing the pallets on the jettison position is embodied in the form of a longitudinal flexible draft with rings which are arranged thereon and whose number corresponds to the number of pallets. The packages are freely arranged on the pallets and reliably fixed by the clamp strips and by friction against the pallet and are easily separable into individual cargoes after being ejected. The pallets are collected in storage sections and reused. Said invention simplifies the structural design of means for disposing cargo in the aircraft and for the jettison thereof without parachuting, increases the reliability and the ease of use of said means thereby ensuring a high economical efficiency thereof.

### THE TECHNICAL LEVEL

The device refers to the equipment of the aircrafts, particularly to the means of cargoes placement on board of the aircraft and the jettison of these cargoes from the aircraft. Most effectively the device may be used for non-parachute jettison of the bulk cargo at small height from the board of the transport planes of, for instance, 11-76 type.

### THE PRECEDING TECHNICAL LEVEL

There are different devices and contrivances know for jettison of the cargoes from the aircraft. In the patent U.S. Pat. No. 3,371,891 A; Mar. 5, 1968 a lifting device in the form of the longitudinal beams at the ceiling of the cargo compartment of the plane is described, which serves for movement of the cargo packages from the storage bunker to the jettison position situated above the cargo ramp. The device provides the successive separation of the cargoes connected by means of the ropes not requiring the launching chases and traditional roller tracks.

In the patent U.S. Pat. No. 4,161,301 A; Jul. 17, 1979 a device for the placement and jettison of pierce cargoes (mines and bullets) on board of the FV is described, that have the means of cargo pushing-out from the pallet, where these cargoes are stored in the trays, and the means of the separation of the cargoes from the trays when landing; the means of connection of the pallets with each other and with the plane are also provided.

In the patent WO 8805398; Aug. 17, 1988 a device for the storage and jettison of the cargoes from board of the FV or from board of any other transport vehicle is described, in which the cargoes are packed at the module construction, assembled of the trays (pallets) that have the separation contrivances for the connection with the transport vehicle. The cargoes are fixed (with the tie rods) in the trays on the pallets with the opportunity of cargoes movement under the influence of the gravity force, after the separation of the trays from the connections with the pallets, to the jettison position, where these cargoes in their own turn are separated by special contrivances from the connection with the trays and are pushed out from the plane.

The above mentioned devices suit for the jettison of the individual and large cargoes, and some of the useful opportunities are not used in them, that are provided in case of bulk and small cargoes in the bag tare.

In the patent RU 2014248 C1; Jun. 15, 1994 a device is described for the usage in the means of strap-down landing of the bulk and small cargoes, such as food, medicines, building materials, etc. The safety of goods (of the package) when landing is provided by means of special form (in the form of the truncated pyramid) of the external packing shell, special construction of the cushioning and cargo shell, the presence of the calibration connections (umbilical cords and laces) and other elements for the consumption of energy of blow on the earth. The described construction of the package is rather complex and expensive—it should be used for small consignments of the landing cargoes.

It should also be mentioned that a range of known devices of non-parachute jettison allows irretrievable loss of the pallets and the like means, which decreases the effectiveness of such a method of jettison when conducting several number of flights.

The most analogous of the offered device is the device for the placement of cargoes on board of the aircraft and their jettison from it at the expense of the powers that occur at the aircraft nosing-up (with the angle of 10°-12°). This device is described in the patent RU 2093424 C1; Oct. 20, 1997. The device includes the pallets for the cargoes placing, which are installed in the cargo compartment along the longitudinal axis of the aircraft, the means of fixation provision of the cargoes packages on the pallets, the contrivances for the fixation of the pallets with the cargoes to the jettison position and the means of fixation of the pallets before the jettison position.

In this known device-prototype each of the means of fixation of the packing of the cargoes on the pallets is made in the form of the net generated of the circular and radial flexible drafts, at this one end of each of the radial draft is connected with the circular flexible draft, and the other end is made in the form of the loop, connected by means of the pin with the other loop fixed at the pallet; at this the guide is installed above the pallets, connected by means of the flexible halyard with all of the pins for the provision of their extract from the loops before the jettison position.

The device-prototype allows using the pallets and the net for the cargoes fixation repeatedly, which reduces the cost of the cargoes jettison.

This technology of non-parachute jettison of the bulk cargoes was used for the first time in 1998 when implementing the aid program to the population of the south of Sudan according to the International food program of U.N.O. (WFP UN) and showed high efficiency as the most economic means of cargo jettison.

However in the course of implementation of this food program U.N.O. found several flaws of this device of cargo placement and jettison, among which the corresponding complexity of the abovementioned means of fixation provision of the cargoes packing at the pallets should be noted. It was found out after the separation of the net of cargoes fixation at the pallet at the moment of jettison; the fall of the separate bags with the goods of the package near the pallet accumulator is not excluded, which may prevent the pushing-out of the cargoes from the other pallets.

Besides, the device prototype has four flexible drafts at each of the board for the fixation of the pallets before the jettison position, which should be connected from the vacant pallets after the pushing-out of the cargo on the pallets, from which the cargoes should be pushed-out in the following flight of the aircraft. This operation complicates the actions of the crew and demands special attention and considerable time, which increases the flight time and correspondingly the cost of cargo delivery.

The limited storage capacitor designed for 4 pallets at each of the board is also one of the flaws, which reduces the maximum amount of the pushed-out cargo per each flight of the aircraft and doesn't allow reducing the required number of flights for the jettison and the gross flight time.

### THE ESSENCE OF THE INVENTION

The task of the offered contrivance is the creation of such a device in which the following would be provided: the simplification of the construction of means for placement of the cargoes on board of the aircraft and their jettison from the aircraft, the increase of the reliability and convenience of these means exploitation, and the increase of the economic efficiency of non-parachute cargo jettison would be its consequence.

This task is solved by the fact that in the device for the placement of the cargoes on board of the aircraft and their jettison from the aircraft, that has the pallets for the packing of the cargoes, installed in the cargo compartment along the longitudinal axis of the aircraft, the means of fixation provision of the packages of cargoes at the pallets, the contrivances for the fixation of the pallets from the longitudinal movement, that give the opportunity, when they are open, of movement of the pallets with the cargoes to the jettison position, and the means for the fixation of the pallets before the jettison position—each of the mentioned means of fixation provision of the packages of cargoes at the pallets includes at least a couple of tie rods that belt the package in the vertical and the like planes and connected with each other above the packing.

In the below mentioned preferred variants of the device implementation some of the cargoes in the packing are placed in the bags (or in the nets).

The tie rods are made in the form of two closed flexible connections placed in the planes parallel and almost parallel to the longitudinal axis of the aircraft and connected with each other by one flexible crosstie above the packing.

The protruding elements are made at the pallets for the prevention of displacement of the packing in the bottom part.

The pallets are installed between the side guides on the roller tracks by which they may be moved under the influence of the horizontal gravity/inertial force component.

The contrivances for the fixation of the pallets from the longitudinal movement are made as detachable.

The means for the fixation of the pallets before the jettison position is made in the form of the united flexible draft placed along the longitudinal axis of the aircraft, both ends of which are connected with the aircraft; at this the place of connection of one end of this draft is situated in the front part of the cargo compartment, and of the other end after the inflection of the draft before the jettison position in the rear part of the cargo compartment; at this for the connection with the pallets the free-range rings are placed at this draft according to the number of the pallets placed along the longitudinal axis of the aircraft.

At this the mentioned device for the fixation of the pallets before the jettison position includes the angle-plates for the roller track, which is situated at the ramp, moreover the height of the mentioned side guides is chosen taking into consideration these plates, and the height of the plates is balanced by the angle of the ramp.

The last variant gives the opportunity to increase the storage capacitor of the pallets after the pushing-out of the cargoes from them.

In the mentioned above group of signs the term “stowage” means a pack, roll, bale, stack and so on—depending on the type of cargo packed on the pallet.

In accordance to the invention, means for stowage fixation on the pallets—in the form of binding the stowage two or more buckles (stripes or drafts)—have no connection with the pallets and other elements of aircraft construction (at least, to the moment of jettison) and disconnected with each other below the stowage.

Such simplified in comparison with prototype cross hatch, construction of present means is possible because frictional force of cargo stowage with the surface of pallet approximately twice increases force influencing on cargo at aircraft nose-up (10-12°) at the time of cargo jettison, which provides stable position of stowage on the pallet in longitudinal direction to the moment of pallet braking before jettison position. Protruding elements (longitudinal stiffening plates) of the pallets are conductive to stable position of stowage in cross direction.

For prevention of stowage displacement in reference to the pallet in other phases of flight standard aircraft chains for cargo fixation in compartment are additionally used, which are unloaded only before jettison of cargo group.

Suggested means for stowage fixation also provide safe, after dropping, division into separate cargo units (preferably sacks with cargo) which guarantees their preservation when landing.

Indication to “inertial force” for cargo movement to jettison position provides possibility of performance of relevant aircraft maneuvers (especially, with acceleration by means of engine reheat at nose-up) during cargo dropping.

Suggested mean for pallets fixation before jettison position instead of four flexible drafts by prototype allows joining all pallets to one braking draft even on the step of their placement in aircraft before loading them.

### LIST OF FIGURES

Subject matter of suggested invention is explained by the following detail description of the example of its performance with attached drawing figures, where the following figures are shown:

FIG. 1—cargo pallet of suggested device (top view);

FIG. 2—the same (bottom view);

FIG. 3—facility for cargo fixation on the pallet (front view);

FIG. 4—the same (top view);

FIG. 5—men for pallet fixation on jettison position;

FIG. 6—scheme of aircraft loading with cargo pallets;

FIG. 7—view A-A at FIG. 6;

FIG. 8—low-ground equipment of cargo compartment of the aircraft (view in plan);

FIG. 9—low-ground equipment of cargo ramp with the pallets in accumulator (view in plan);

FIG. 10—view B-B at FIG. 8;

FIG. 11—example of the facility for pallet fixation from longitudinal movement;

FIG. 12—view C-C at FIG. 11.

### THE BEST VARIANT OF INVENTION IMPLEMENTATION

The invention can be effectively realized on such aircraft as transport airplane II-76, jettisoning cargo at the height of 200-250 m at flight speed of 280-300 km/h. Different free-running things (grain, grit and other) in triple sacks or other cargo in package providing its safety when landing may serve as cargo.

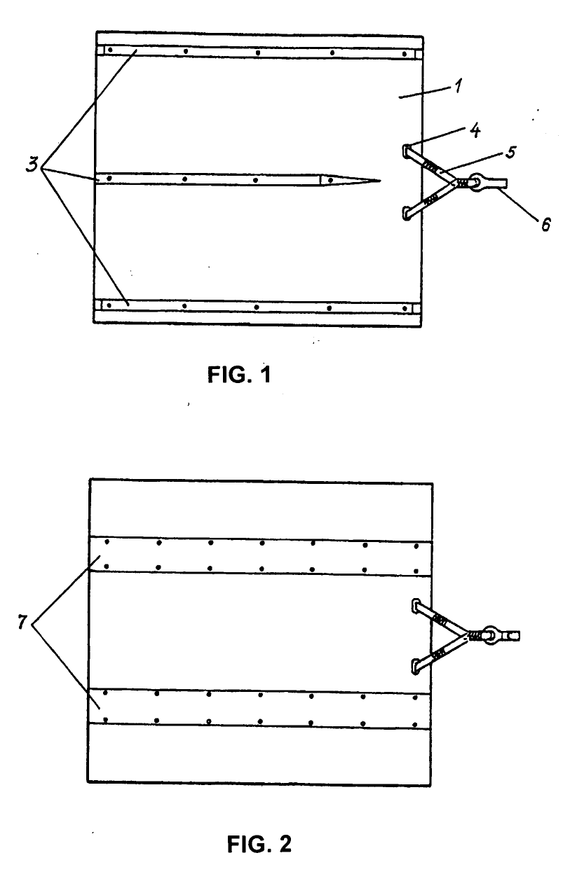

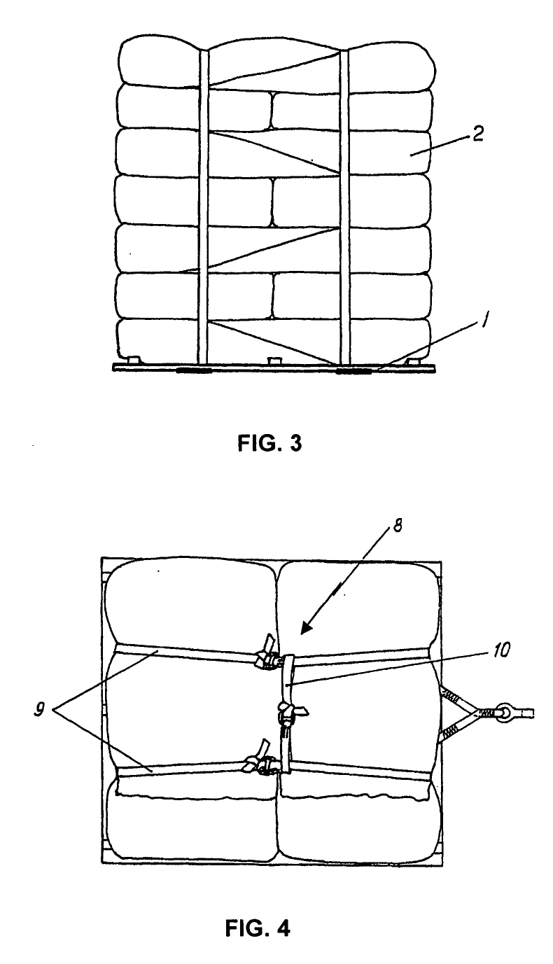

The device for cargo placement and jettison contains pallets 1 (FIG. 1-5) for putting on them cargo 2. Each pallet 1 is made preferably out of veneer wood of 18 mm thickness and has on its upper side protruding elements, for example, three longitudinal stiffening plates 3, made out of veneer wood of the same thickness. On one cross side of pallet 1 there are two holes 4 where the ends of flexible draft 5 are fixed, which at another end has latch hook 6. On the lower side of pallet 1 two metal strips 7 are fixed.

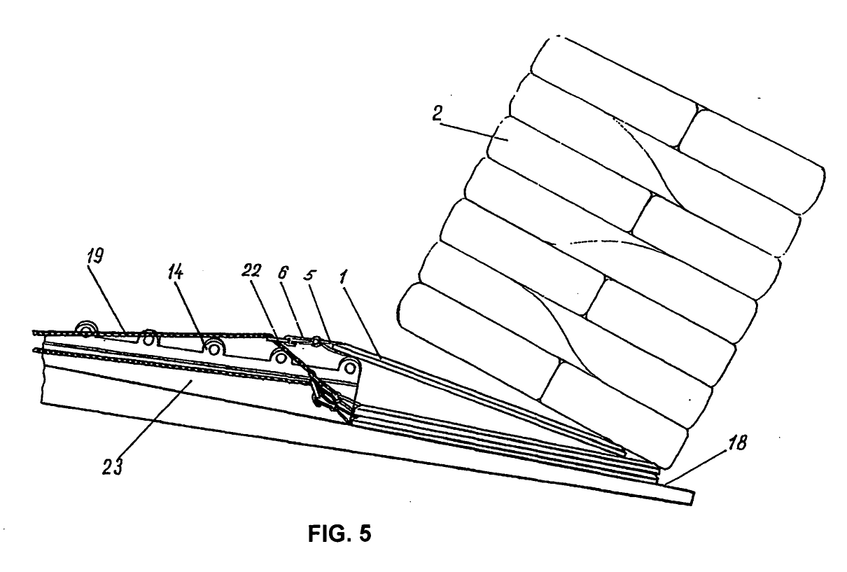

The device includes (FIG. 4) the means 8 of stowage fixation on pallets. Each such mean 8 contains at least a pair of buckles (locked flexible connections: drafts, stripes, wires and so on), binding the stowage in vertical and near to them plains (at the moment of aircraft loading) and connected with each other above stowage, for example, by one cross flexible connection 10. Buckles, preferably, are placed in the plains parallel or near to parallel longitudinal aircraft line.

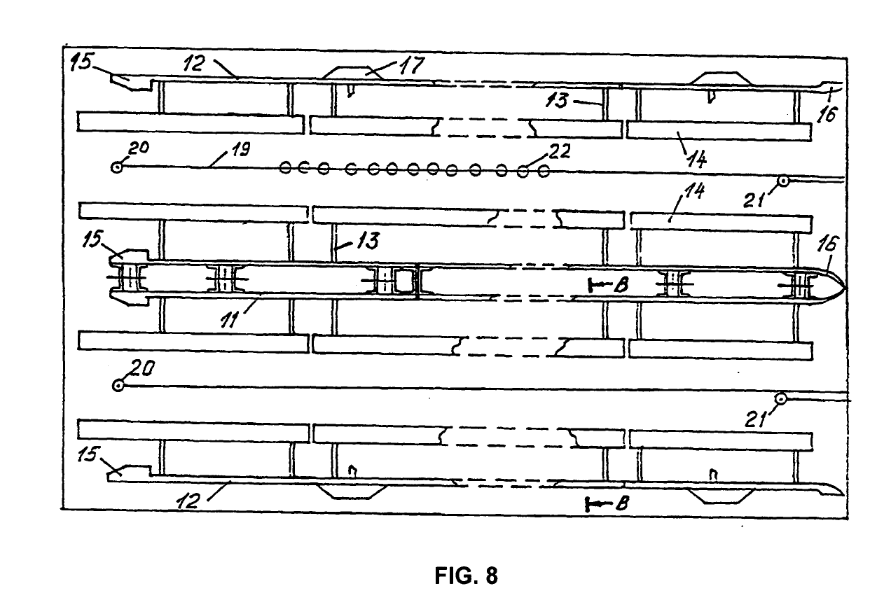

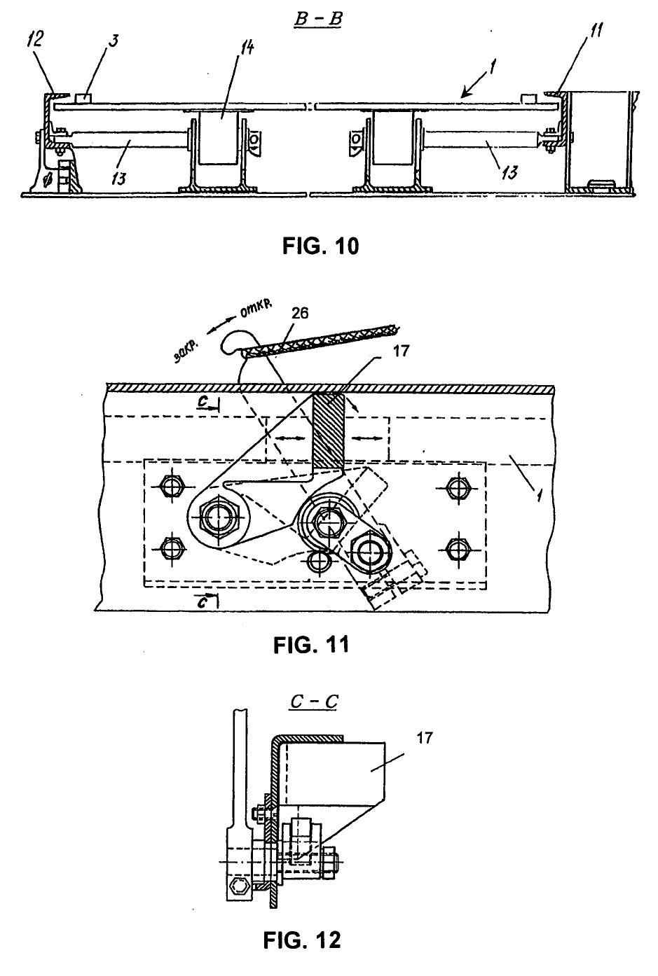

The parts of the device are facilities for pallets fixation from coplanar motion, allowing when opening them the possibility of movement of pallets with cargo to the jettison position. At FIG. 7-10 appropriate floor equipment is shown which is designed for placement of pallets 1 with cargo 2 in cargo compartment of the plain and ensuring their directed movement along the compartment during loading and jettison. The equipment is easy-off and contains (FIG. 8) central 11 and side 12 guiding railing on which with the help of plungers 13 roller strips 14 are assembled for pallets' rolling.

Upper racks and vertical plates of both parallel railings 11 and 12 serve as guiding for pallets 1 at their movement along cargo compartment when loading and jettison of cargo, and in flight hold pallets with cargo from side and vertical movements.

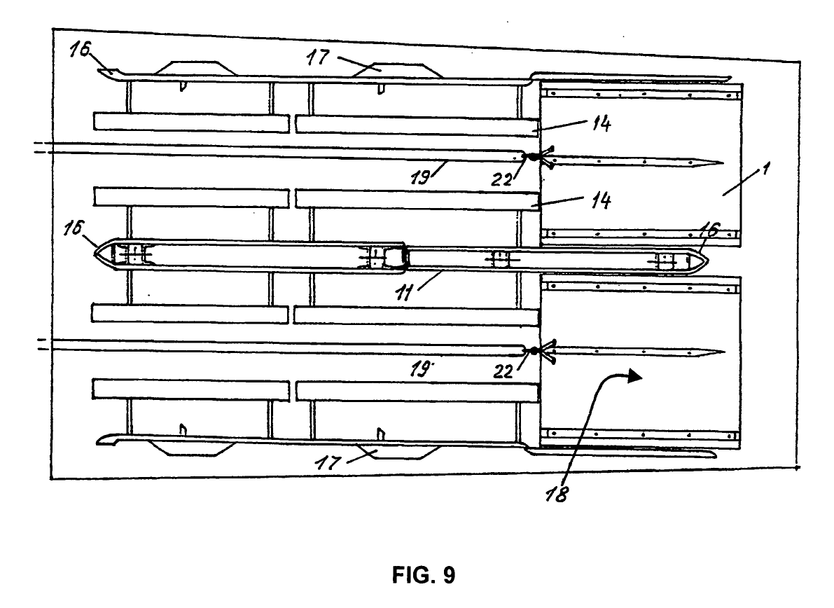

In the front by direction of the flight part of the guiding railings 11,12 two stops 15 are fixed for movement limitation of the first by loading pallets 1 in the direction of crew compartment. At the ends of guiding railings by the beginning of cargo compartment and at ramp retarders 16 (FIG. 8-9) are installed providing safe start of pallets 1 into guiding railings 11 and 12 at the movement of pallets from cargo compartment to ramp and vice-versa.

The parts of the device are detachable facilities 17 placed on the side guiding railings 12 designed for pallets fixation from coplanar motion in the guiding railings 11, 12. Locks of pallets fastening, example of one of which is given at FIG. 11, may be used as facilities 17. Locks may be opened with help of halyards 26.

The device also contains tool for fixation of pallets 1 before landing position, providing arrival of pallets 1 in accumulators 18 (FIGS. 5,9), placed behind roller strips 14 at the edge of ramp.

This tool (FIG. 8-9) is made in the form of elastic flexible draft 19 one end of which is attached to tie-down assembly unit 20 on the floor of plain, and the other end of draft 19, extended to accumulator 18 and after hogging backwards, is attached to tie-down assembly unit 21. Point of flexible draft hogging 19 is located in front of accumulator 18 at distance which provides braking of pallet 1 in accumulator 18 and, after its release, pressing to flank of roller strip 14.

On each flexible draft 19 of right and left boards by thirteen rings 22 are placed to which with the help of latch hooks 6 pallets 1 are attached.

The tool for fixation of pallets 1 in accumulator 18 contains angle-plate 23 (FIG. 5) which is fastened under roller strip 14. Angle-plate increases the height of accumulator threshold 18 and accordingly its capacity, functioning as stop at back movement of pallet 1 after discharging from it a package of cargo 2 owing to tension of flexible draft 19.

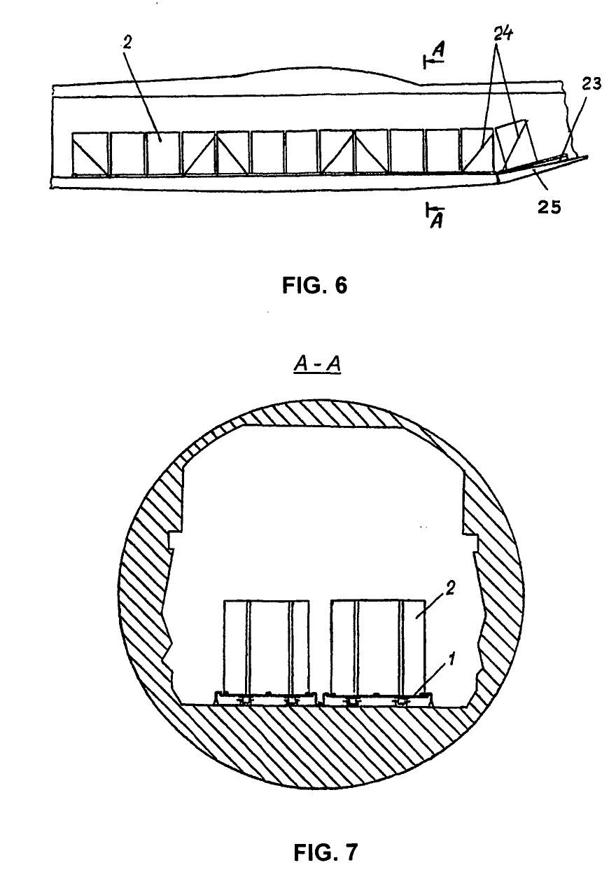

The device also contains standard chains 24 for additional fastening of pallets with cargo to the floor of plain before performance of start on jettison and inclinable cargo ramp 25 (FIG. 6).

On stream the suggested device works in the following manner.

Before loading of the plain all pallets 1 are placed in it. For this purpose each pallet 1 is installed at ramp 25 on roller strip 14 between guiding railings 11, 12 directly at front of accumulator 18, and then manually is pushed to cargo compartment of the plain up to the stop and fixed by one of the facilities 17. In that way in the plane along each board by 12 pallets in cargo compartment and by one pallet at ramp are placed.

Each pallet 1 located in the plane is loaded with cargo in sacks (or racks) of 1250-1500 kg mass, having before put two drafts 9 on the pallet by the line of roller strip 14, having symmetrically distributed the ends of drafts 9 relatively to the centre of pallet 1. After the sacks are set on pallet 1 their roll is tied up with lateral drafts 9 which are bundled up. Then the drafts 9 are connected with each other over the roll with the short draft 10, which provides rigidity of cargo roll 2 in cross direction.

After loading of all pallets 1 with cargo 2 a flight navigator determines number of pallets out of which the load is dropped in each aircraft approach on the basis of accumulator capacity 18 and the spread of cargo acceptance region 2 in landing area. Each group of pallets 1 with cargo 2 in one aircraft jettison approach is fastened to the floor of plane with the help of standard chains 24.

To the facility 17 of the first, in order of dropping, pallet a halyard 26 (FIG. 1) for manual opening by operator of the lock at cargo dropping is affixed. The facilities 17 of the following in this series pallets are affixed with halyards (not shown at the figures), each to the pallet located in front by the exit from cargo compartment. Then the hatch of aircraft cargo compartment is closed.

At flight tangent to the landing zone under a command of flight navigator a ramp is opened and operator unloads the chain 24 of pallets 1 fastening with cargo 2 of the first series on the side of ramp.

At approach to the jettison area in reference point a plane commander under a command of flight navigator puts the aircraft from forward flight in nose-up condition with the angle of 10°-12°. Under a command of flight navigator operators by left and right boards open with the help of halyards 26 facilities 17 of the first by exit pallets 1, and they start moving under the influence of gravity force component (and, possibly, of inertia).

Opening of the facilities 17 of the following in these series pallets 1 is happened after tensioning of halyards linking the facilities 17 of these pallets 1 with the first by exit pallets 1 at the beginning of movement of the latter.

At the moment of turnoff of pallet 1 with cargo roll 2 out of the last rolling element of roller strip 14 a tensioning of flexible draft 19 takes place what leads to braking of pallet 1 which “breaks down” in accumulator 18, and cargo roll 2 is dropped of the aircraft. Free pallet 1 under the influence of tension force of flexible draft 19 is moving in backward direction, thrusts against flank of angle-plate 23 (FIG. 5) of roller strip 14 and remains in accumulator 18.

Dropping of stowage 2 of the following pallets 1 is happened in analogous way. Accumulation of pallets 1 takes place in accumulator 18.

For compensation of inclination of the plates 23 under roller strip 14 on ramp 25 (FIG. 5), this ramp, when opening before landing, is descended on necessary angle.

Stowage, dropped with the pallet 1 is being broken down into separate loads 2 (for example, sacks), as buckles 9 being not tied with each other from below, move apart and don't hold cargo in stowage any more. The ram air is also conductive to it. Cargo 2, in comparison with their compact roll or pack, more effectively “pancake” and experience less buffing loads when landing (as in stowage, upper sacks would create additional load on lower).

After dropping of the first series of cargo 2 off the pallets 1 operator closes hatch of cargo compartment, the pallets 1 are taken away from accumulator 18 and vertically fastened to the boards of the aircraft.

The next series of pallets 1 with cargo is released from additional chains 24, rolled over to the ramp, fixed with facilities 17 and attached with halyard openings as for the previous series of cargo.

Cargo dropping 2 off the next pallets is happened analogous to cargo dropping 2 of the first series.

In such way, suggested device is distinguished by simple design, significant cutting time of cargo fastening on the pallet and, as the result, cutting time of flying vehicle load. The necessity of reconnection of draft to the pallets in flight after each aircraft approach for cargo jettison is excluded, crew performance reliability is simplified and increased, and block hours are reduced.

The suggested device allows to increase capacity of pallet accumulator and, as consequence, required maximally possible number of dropped cargo for one approach of FV, and also possibility to increase thickness and resistance of pallets. By this, pallet recourse and possibility of performance of more shipments is increased, which leads to reducing of delivering cargo cost.

### INDUSTRIAL APPLICABILITY

In suggested device officially accepted in practice of cargo free dropping technical means and processes are used. At the heart of its creation an experience of cargo landing off production aircrafts is put, in particular, II-76, with the heights of 200-250 m at flight speeds of 280-300 km/h.

1. Device for cargo placement on aircraft and its jettison off it, containing pallets for stowage, installed in cargo compartment along lateral line of the aircraft, means of providing of stowage fixation, facilities for pallets fixation from lateral movement, giving when opening them possibility of movement of pallets with cargo to the jettison position, and also mean for pallets fixation before jettison position, distinguished by the fact that each of its indicated means of providing of stowage fixation on the pallets contains at least a pair of buckles, binding stowage in vertical and near to them plains and connecting with each other over the stowage.

2. The device of claim 1, distinguished by the fact that separate loads in stowage are placed in sacks.

3. The device of claim 1, distinguished by the fact that buckles are made in the form of two locked flexible connections, located in the plains parallel or near to parallel lateral line of the aircraft and connected with each other by one cross flexible connection over stowage.

4. The device of claim 1, distinguished by the fact that on the pallets there are protruding elements for prevention of shifting and creeping of stowage in their lower part.

5. The device of claim 1, distinguished by the fact that the pallets are installed between side guide tracks on roller strips by which they can move under the influence of horizontal gravity force or/and inertial force component.

6. The device of claim 1, distinguished by the fact that indicated facilities for pallets fixation from lateral movement are made as detachable.

7. The device of claim 1, distinguished by the fact that mean for pallets fixation before jettison position is made in the form of one flexible draft located across lateral line of the aircraft, both ends of which are connected with the aircraft, at that, point of connection of one end of this draft is located in front part of cargo compartment, and of another, after draft fluting before jettison position in the back part of cargo compartment, where for connection with the pallets on this draft freely shiftable rings are located by number of pallets placed along lateral line of the aircraft.

8. The device of claim 7, distinguished by the fact that the indicated mean for pallets fixation before jettison position contains angle-plates for roller strip which is placed on ramp, where the height of the indicated side guide tracks is chosen taking into consideration plate data, and the height of the plates is compensated by ramp inclination.
